(19) United States
(12) Patent Application Publication
(10) Pub. No.: US 2026/0242105 A1
(43) Pub. Date: Aug. 20, 2026

(54) Bottle Top With Pill Caddy

(71) Applicant: Edward Leroy Pencoske, Trafford, PA (US)

(72) Inventor: Edward Leroy Pencoske, Trafford, PA (US)

(21) Appl. No.: 19/053,737

(22) Filed: Feb. 14, 2025

(51) Int. Cl. B65D 51/28; A61J 1/14; B65D 51/18

(52) U.S. Cl. CPC B65D 51/28; A61J 1/1418; B65D 51/18; B65D 2251/0021; B65D 2251/0078

(57) ABSTRACT

The present invention is directed to a bottle top comprising a lower portion having an upper end and a lower end. Threads are carried by the lower end. The bottle top has an upper portion having a lower end and an upper end with the lower end positioned on top of the upper end of the lower portion. A solid wall separates the upper portion from the lower portion. The wall and the upper portion define a space. A lid, constructed of a substantially see-through material, is configured to engage the upper end of the upper portion. The lid operates between an open position enabling access to the space and a closed position preventing access to the space. The entire assembly may be molded as one piece and all, or portions thereof, may be made of a material to enable the contents to be seen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPITICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present invention is directly broadly to the field of dispensing medicaments and, more specifically, medicaments in the form of pills, e.g. prescription medicines, over the counter (OTC) medicines, vitamins, etc.

### Description of Related Art

Surveys show that 131 million people, 66 percent of all adults in the United States, use prescription drugs. That number swells when estimates of the number of people taking OTC medicines, vitamins, dietary supplements, or other types of pills to improve the quality of their lives or to deal with temporary conditions are added in. It is further estimated that 40% of older adults take five or more prescription drugs and almost 20% are on ten drugs or more. According to the CDC, the most likely cause of accidental death for people 60 and over is unintentional poisoning, primarily from overdoses and drug interactions.

While many adults and older people are completely capable of taking these daily medications on their own, it often becomes difficult for them to remember if they did or didn't take a particular drug. Many solutions to this problem exist in the art.

For example, one attempt to solve the problem involves bottle tops that include a dial or other type of indicia that show the last time a medicine was taken. See, for example, U.S. Pat. No. 4,501,370 to Kelley entitled Medicine Bottle Closure Having An Indicator; U.S. Pat. No. 5,009,338 to Barker entitled Indicator Cap for a Medicine Bottle; U. S U.S. Pat. No. 5,377,614 to Glazer entitled Reminder Device for Pill Containers; and U.S. Pat. No. 7,314,022 B2 to Sollaccio entitled Medicine Bottle Cap With Time And Day Markers.

U.S. Pat. No. 5,351,818 to Daneshvar entitled Medicine Box discloses a box having storage space for pill bottles and above this storage space is a ledge on which a weekly pill container box rests. The weekly pill container box contains a week's supply of pills in daily compartments and has a unique arrangement of doors for opening and closing the compartments.

U.S. Pat. No. 3,675,620 to Baustin entitled Means for Recording Medicinal Dosages includes a pill bottle container having storage for pill bottles. Above the pill bottles is a marker storage receptacle for holding a supply of markers. The container has a band having segments corresponding to the number of pill bottles stored with the segments carrying day and time indicia. When medicinal dosages are taken, markers are inserted into the appropriate location in the band to provide a record of the dose haven been taken.

U.S. Pat. No. 4,693,371 to Malpass entitled Medication Dispenser and Container discloses a rectangular dispensing container having cavities divided into two parts. A first part is open to the user to enable the user to place medication therein and to remove medication therefrom. A second part is closed off from direct access by the user in semi-permanent fashion by a transparent enclosure and is used to contain an example of the appropriate dosage of medication to be taken.

U.S. Pat. No. 4,473,156 to Martin entitled Method and Apparatus for Accurately Selecting Storing and Dispensing Pills discloses a rectangular tray having color coding and other indicia. The tray is loaded by putting each pill in the appropriate compartment.

U.S. Pat. No. 3,225,913 to Lee entitled Capsule and Tablet Pocket Carrier is a rectangular device hinged on both sides. On one side medicaments can be accessed and on the other side dosing information can be stored.

Blister packaging is also known in the art to simplify the taking of medications. See, for example, U.S. Pat. No. 7,637,079 B2 to Klingel et al. entitled Installation for Filling Packaging Units With Medicaments for Patients According to the Prescribed Weekly Requirements.

Another attempt to solve the problem involves bottle tops having some mechanism for communicating with the contents of the bottle to enable a pill to be dispensed by manipulating the bottle top. See, for example, U.S. Pat. No. 3,991,908 to Thomas et al. entitled Pill Dispenser; U.S. Pat. No. 5,791,515 to Khan et al. entitled One At A Time Pill/Medication Dispenser; U.S. Pat. No. 10,457,472 B2 to Sanders entitled Combination Medicine Containers and Dispensers; U.S. Pub. No. US 2014/0305963A1 to Zonana et al. entitled Smart Cap System; and U.S. Pub. No. US 2007/0007301 A1 to Kaplan et al. entitled Pill Dispensing Container Elements and Methods.

U.S. Pat. No. 4,432,300 to Lyss entitled Pill Dispenser With Sequential Dispensing And Indicating Cap has both indicia on the cap and openings in communication with the contents of the bottle.

Although the prior art has advanced several solutions to the problem of remembering whether or not a pill has been taken, that problem has not been satisfactorily solved. Some prior art solutions simply move the problem from remembering to take the pill to remembering to advance some type of indicia. In the case of blister packs, their availability is out of the control of the patient. Other solutions are complicated devices that require mechanical manipulation to retrieve a pill from a bottle. Still other solutions rely on complicated systems that require substantial set up time as well as removing the medicament from the bottle received form the pharmacy thereby separating the medicament from valuable information.

### BRIEF SUMMARY OF THE INVENTION

The present invention overcomes the deficiencies of the prior art by enabling an individual to know whether they did or did not take their daily medication by simply looking at the prescription bottle in which the drug came.

In its simplest form, the present invention is a bottle top comprising a lower portion having a lower end and an upper end and an upper portion also having a lower end and an upper end. In one embodiment, threads are carried by the lower portion, either internally or externally. The lower end of the upper portion is positioned on top of the upper end of the lower portion. A wall separates the lower end of the upper portion from the upper end of the lower portion. The wall and the upper portion define a space which may be thought of as a vial or a pill caddy. The wall prevents communication between the space and the lower portion. A lid constructed of a substantially see-through material is configured to engage the upper end of the upper portion such that the lid can be moved between an open position enabling access to the space and a closed position preventing access to the space

When the threads are carried on the exterior of the lower section, the bottle top of the present invention may be screwed into the unused end of a prior art bottle top.

The bottle top may be constructed in childproof and non-childproof configurations. Different colors may be provided to distinguish between patients in the same household.

An advantage of the present invention is that it keeps the drug and the prescription drug bottle together until the moment the pill is taken. Maintaining the drug and the prescription drug bottle together is vital because the label on the prescription drug bottle lists important information, i.e. the patient name, the drug name, the drug dosage, the time when the drug is to be taken, and how the drug is to be taken. This information is sometimes referred to as the five rights. Keeping the drug and the prescription bottle together until the drug is taken insures that the right person, takes the right dose, of the right drug, at the right time, the right way.

Another advantage of the present invention is that if a person is found unconscious, by looking at the prescription bottles, vital information about what drugs have been taken that day and what drugs have not been taken can be quickly ascertained.

These, and other advantages and benefits, will become apparent from the description below.

### BRIEF DESCRIPTION OF THE SEVERAL VIEWS OF THE DRAWINGS

FIG. 1 is a perspective view illustrating a prior art prescription bottle and bottle cap or top;

FIG. 2 illustrates a prior art label of the type found on a prescription bottle;

FIG. 3 is a perspective view illustrating a bottle top constructed according to the teachings of the present invention with the lid of the bottle top closed;

FIG. 4 is a perspective view illustrating the bottle top of FIG. 3 with the lid of the top open;

FIG. 5 is a perspective view of the bottle top of FIG. 3 looking up into the bottom of the bottle top;

FIG. 6 is a side plan view of the bottle top of the present invention with the lid open;

FIG. 7 is a cross-sectional view of the bottle top of the present invention taken along the lines VII-VII in FIG. 6;

FIGS. 8 and 8A illustrate a childproof version of the bottle top of the present invention;

FIG. 9 illustrates another embodiment of the present invention in which the bottle top has threads for engaging the threads in the unused end of a prior art bottle top;

FIGS. 10 and 11 illustrate alternative embodiments of the present invention wherein the pill caddy is provided with compartments; and

FIG. 12 illustrates another embodiment of the present invention.

### DETAILED DESCRIPTION OF THE INVENTION

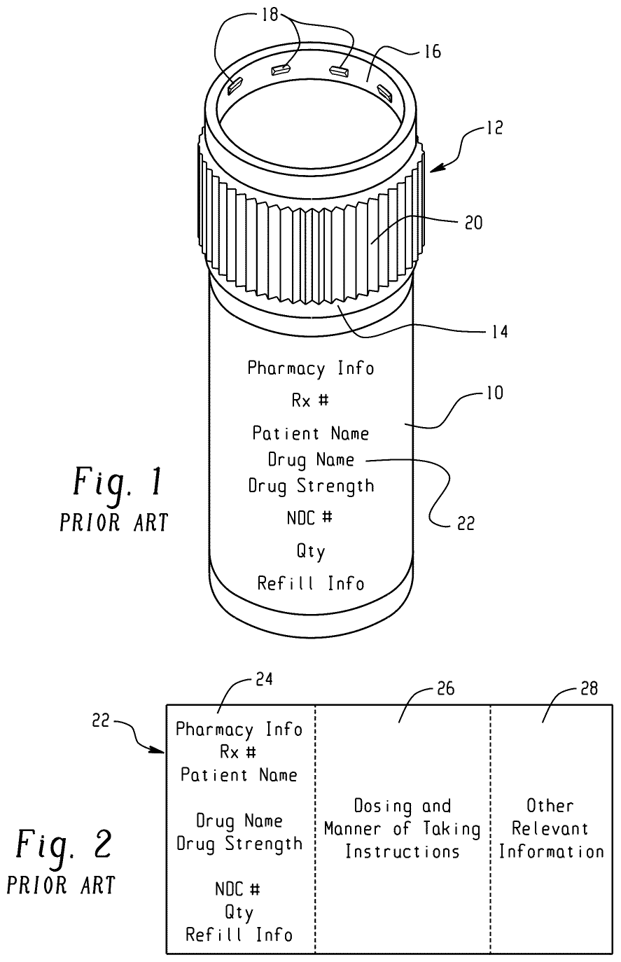

FIG. 1 illustrates a prior art prescription pill bottle 10. The most common design of the prescription bottle 10 in North America is the amber colored bottle which has been in use since the 1940s. The amber color of these bottles 10 protects the contents from ultraviolet light while still allowing some light to pass through. The only major change to the design since its introduction has been the addition of a child-safety cap in the 1970s.

Prior art pill bottles 10 can be obtained from a variety of suppliers. The bottles come in a variety of volumes and, despite the difference in volumes, most manufacturers use a neck and threads of a standard size so that all, or most of their bottles, can use the same size cap. While the present invention is described in the context of a prescription bottle, bottles carrying other types of pills, e.g. OTC pills, vitamins, health supplements, and the like, may be used with the present invention.

The pill bottle 10 is provided with a prior art cap 12. Such caps 12 are well known in the industry and are used by many retail pharmacy chains. Because the bottles 10 have standard sized necks and threads, one size of cap can be used with bottles of different volumes.

The cap 12 has a bottom portion 14 and a top portion 16. The bottom portion 14 has threads, not shown, for engaging the threads, not shown, of the bottle 10 to securely close the bottle. The bottom portion 14 is designed to be childproof. The top portion 16 has a series of protrusions 18 arranged to act like threads for engaging the threads of the bottle 10 to securely close the bottle. The top portion 16 is not childproof. In that manner, the customer can choose to use either a childproof cap or a non-childproof cap simply by choosing to use either the bottom portion 14 or the top portion 16, respectively, to close the bottle 10.

The cap 12 may be further provided with ridges 20 to make it easier to grip the cap 12. Finally, the bottle 10 carries a label 22 carrying various information. The label 22 is shown in greater detail in FIG. 2.

FIG. 2 illustrates a typical prior art label 22. The label 22 may be divided into three areas as is known in the art. Area 24 has fields containing information such as pharmacy information, prescription number, i.e. Rx number, patient name, drug name, drug strength, NDC number, quantity information, and refill information, among others. A second area 26 of the label 22 may contain information such as dosing information and information about how to take the drug, e.g. take two pills by mouth at bedtime, among other information. Finally, a third area 28 may contain other relevant information such as what the medication looks like, potential side effects, what the medication does, federal warnings, and the like. It is important to note that the label 22 complies with the five “rights” of medication administration. Specifically, the label identifies the patient, the drug, the dose, the time to take the drug, and how to take the drug.

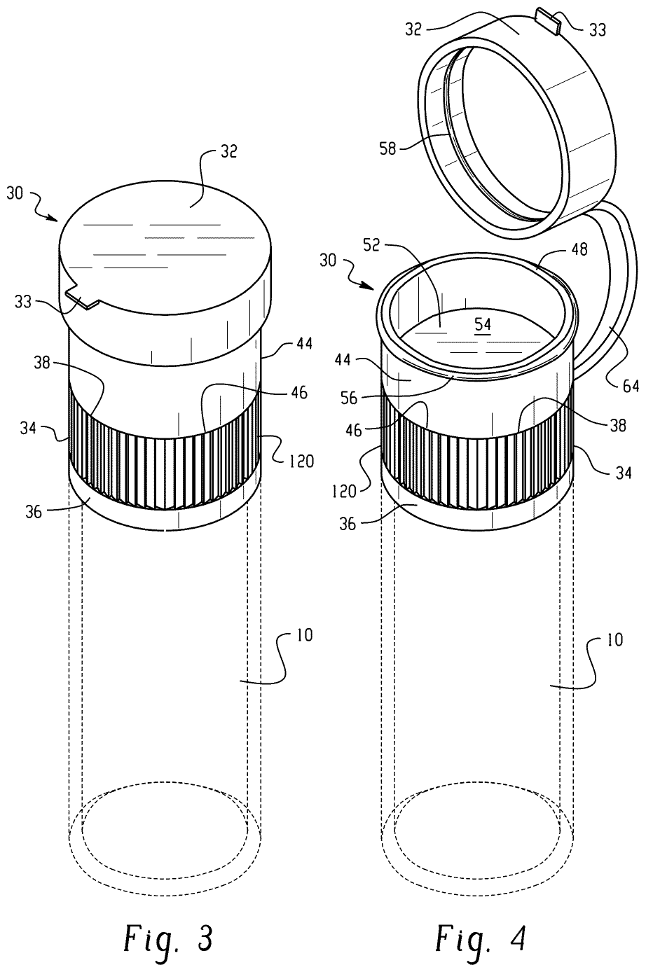

The bottle top 30 of the present invention will now be described in conjunction with the various figures, and in particular, FIGS. 3 through 7. In all the figures, the prior art bottle 10 is shown in dashed lines.

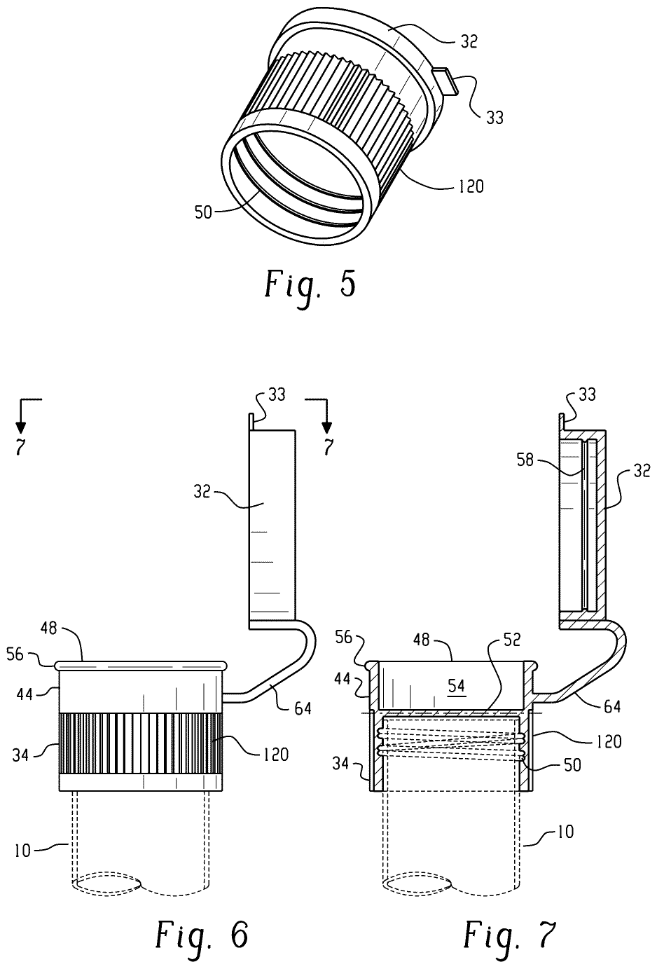

The bottle top 30 is comprised of a lower cylindrical portion 34 having a lower end 36 and an upper end 38 and an upper cylindrical portion 44 also having a lower end 46 and an upper end 48. Although in the preferred embodiment the upper portion 44 is described as being cylindrical, other shapes, e.g. square, rectangular, etc. may be used. Threads 50 are carried by the lower cylindrical portion 34 either internally as shown in FIG. 5 or externally as shown in FIG. 9.

The lower end 46 of the upper cylindrical portion 44 is positioned on top of, and connected to, the upper end 38 of the lower cylindrical portion 34. A wall 52, see FIG. 4, completely separates the lower cylindrical portion 34 from the upper cylindrical portion 44. The wall 52 and the upper cylindrical portion 44 define a space 54 which may be thought of as a vial or a pill caddy. The wall 52 prevents communication between the space 54 and the lower cylindrical portion 34. Thus, when the lower cylindrical portion 34 is connected to the pill bottle 10, the wall 52 always prevents any pills in the bottle 10 from entering the space 54.

A lid 32 constructed of a substantially see-through material is configured to engage the upper end 48 of the upper cylindrical portion 44 such that the lid 32 can be moved between an open position, see FIG. 4, enabling access to the space 54, and a closed position, see FIG. 3, preventing access to the space 54. As used herein, a substantially see-through material means a material which does not impede a user from seeing whether any pills are in space 54.

Many types of lid configurations may be used as is known in the art. For example, and as seen best in FIGS. 6 and 7, a non-childproof lid configuration is illustrated. Upper end 48 of upper portion 44 may be provided with an outward flare 56. In this configuration, lid 32 is provided with a ring 58 along its interior side wall. Lid 32 can thus be pressed onto upper end 48 to enable the ring 58 to snap over flare 56 so as to secure the lid 32 onto the upper cylindrical portion 44. Pushing up on a tab 33 carried by lid 32 enables the ring 58 to be pushed up and over the flare 56 to enable the space 54 to be accessed.

Completing the description of the pill bottle 10, a flexible hinge 64 may be optionally provided. The hinge 64 is connected to both the lid 32 and the upper cylindrical portion 44 to keep the lid 32 from getting lost. The length of the hinge 64 and the connection point of the hinge 64 to the upper cylindrical portion 44 are sized and located, respectively, so as not to impeded operation of the lid 32 between its closed and open positions. Finally, ridges 120 may be carried by either lower cylindrical portion 34 as seen in FIG. 6 or upper cylindrical portion 44 as seen in FIG. 9.

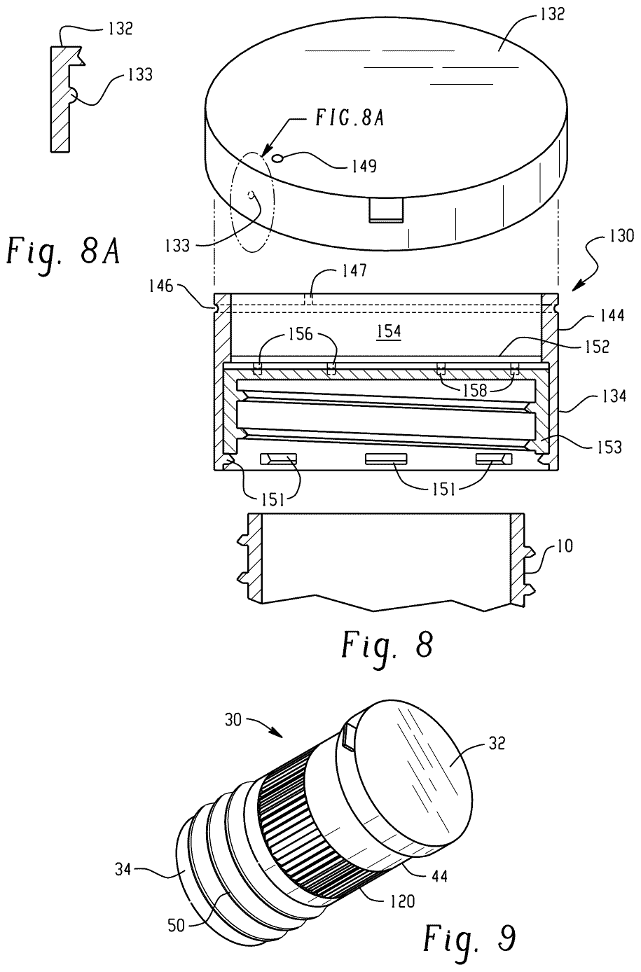

A childproof bottle top 130 constructed according to the teachings of the present invention is illustrated in FIGS. 8 and 8A. As is apparent, if a childproof or child safety-cap type connection is needed between the bottle top 130 and bottle 10, then a childproof or child safety-cap connection will also be needed to prevent unwanted access to space 154.

As shown in in FIGS. 8 and 8A, the lid 132 is provided with a protrusion 133 on the interior side wall of the lid 132. The upper cylindrical portion 144 is provided with a groove 146 along the circumference of the exterior side wall. The groove 146 is accessed via a key-way 147. The lid 132 may be used to close the space 154 by first aligning protrusion 133 with key-way 147 and then pushing down on the lid 132. After the protrusion 133 accesses the groove 146, rotating the lid 132 misaligns the protrusion 133 and the key-way 147 thereby preventing removal of the lid until such time as the protrusion 133 and key-way 147 are brought back into alignment. Indicia 149 may be provided on the lid and on the upper portion 144 (not shown) to aid in the alignment of the protrusion 133 and the key-way 147. Such child-safety caps are known in the art and need not be described further herein.

Referring again to FIG. 8, the lower cylindrical portion 134 carries protrusions 151 which loosely hold a cylindrical threaded member 153 within lower cylindrical portion 134. Wall 152 carries teeth 156 along the circumference of its underside. Threaded member 153 carries openings 158 along the circumference of its top-side. When the bottle top 130 is attached to the bottle 10, and the teeth 156 are not engaged with openings 158, the bottle top 130 is free to rotate relative to the bottle 10 such that the bottle top cannot be removed. When the bottle top is pushed downward and the teeth 156 are brought into engagement with openings 158, the bottle top becomes rigidly connected to threaded member 153 such that rotation of the bottle top 130 enables the bottle top to be removed from bottle 10. Such child-safety caps are known in the art and need not be described further herein.

Referring now to FIG. 9, it has been previously noted that the threads 50 may be carried on the exterior of the lower cylindrical portion 34. In this configuration, the bottle top 30 of the present invention may be screwed into the unused threads of the prior art bottle cap 12 of the type shown in FIG. 1 thereby effectively adding a pill caddy to the prior art bottle top 12. The connection between the prior art bottle top 12 and bottle top 30 of the present invention need not be childproof because if the connection between the prior art bottle top 12 and the pill bottle 10 is childproof, and the connection between the lid 32 and upper cylindrical portion 44 of bottle top 30 of the present invention is childproof, then the child cannot access medication in the pill bottle 10 or the space 54, respectively.

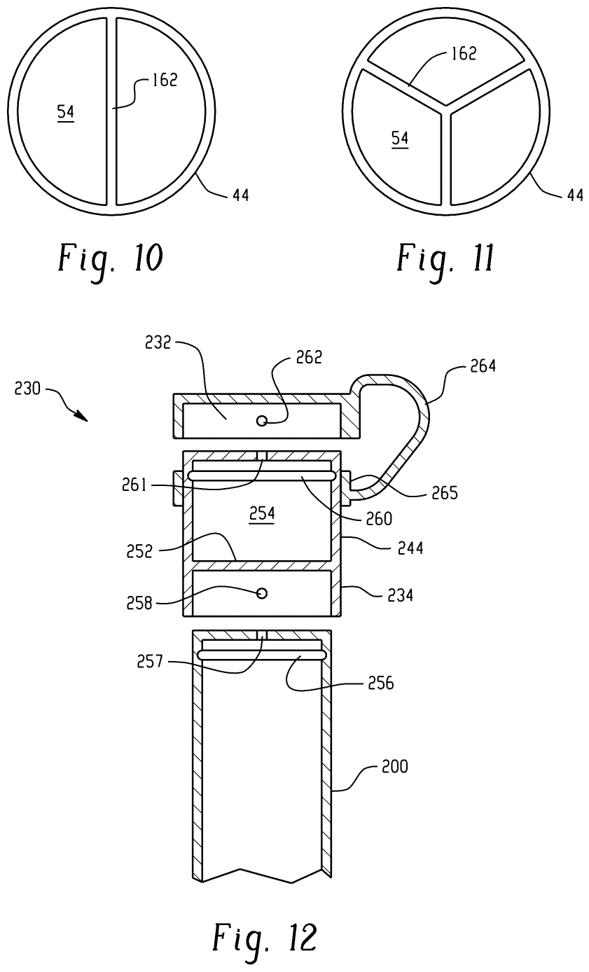

FIGS. 10 and 11 illustrate how the spaces 54 and 154 of the upper cylindrical portions 44 and 144, respectively, may be configured if more than one pill per day must be taken. In FIG. 10, a divider wall 162 is provided which divides the space 54 into two portions while in FIG. 11, the divider wall 162 divides the space 54 into three portions. In FIGS. 10 and 11, the divider wall 162 is shown integrally molded into the side wall of the upper cylindrical portion 44. Alternatively, the divider wall 162 may be a separate piece which is inserted into upper cylindrical portion 44.

FIG. 12 illustrates another embodiment of the present invention which may be used in connection with a prior art bottle 200 of a type which is not threaded. A bottle top 230 constructed according to the teachings of the present invention has a lower cylindrical portion 234 and an upper cylindrical portion 244 separated by a wall 252. The upper cylindrical portion 244 and the wall 252 form a space 254. The space 254 is accessed by a removable see-through lid 232.

The upper end of the prior art bottle 200 is provided with a groove 256 accessed by a key-way 257. A protrusion 258 carried on the interior wall of the lower cylindrical portion 234 is sized to operate with key-way 257 and groove 256 to provide a child-resistant connection between the bottle top 230 and the prior art bottle 200. Similarly, the upper cylindrical portion 244 is provide with a groove 260 accessed by a key-way 261. A protrusion 262 carried on the interior wall of the lid 232 is sized to operate with key-way 261 and groove 260 to provide a child-resistant connection between the lid 232 and the space 254. A hinge 264 may be provided to connect the lid 232 to an outer wall of the upper cylindrical portion 244. The space 254 may be divided into individual compartments as shown in FIGS. 10 and 11.

The various embodiments disclosed herein may be constructed as an integrally molded, single piece. For example, the lower portion, threads, upper portion, and wall dividing the lower and upper portions may be molded as a single piece to be used with a separate lid. The entire molded piece, or portions thereof, may be see-through. Alternatively, the lower portion, threads, upper portion, wall dividing the lower and upper portions, hinge, and lid may be molded as a single piece with the entire piece, or portions thereof, being see-through. Such a construction could be made childproof, for example, by designing the hinge 264 in FIG. 12 to hold the lid 232 in a position where the keyway 261 and protrusion 262 are misaligned. Sufficient flexibility of the hinge would allow the lid 232 to be twisted into a position where the keyway 261 and protrusion 262 are in alignment. As an alternative, the lid 232, hinge 264, and a friction fit collar 265 may be molded as one piece.

In use, once a day, preferable at the end of the day, a person will remove the bottle top of the present invention to access the contents of the bottle. A daily dose of the medication is removed and the bottle top is replaced on the bottle. The lid is then opened and the daily dose is placed in the space 54, 154, 254. The lid is then closed. The next day, all of the person's drugs they are to take that day are in the see-through pill caddy on top of the prescription bottles in which they came.

One advantage of this invention is that it keeps the drug and the prescription drug bottle together until the moment the pill is taken. Maintaining the drug and the prescription drug bottle together is important because the label on the prescription drug bottle lists important information, i.e. the five rights: the patient name, the drug name, the drug dosage, the time when the drug is to be taken, and how the drug is to be taken. Keeping the drug and the prescription bottle together until the drug is taken insures that the right person, takes the right dose, of the right drug, at the right time, the right way.

Any time during the day, anyone can scan the see-through tops of the pill caddies to see if that day's medication has been taken. The person can easily pick up the bottle and review the label to see when and how to take the drug.

While the present invention has been described in connection with preferred embodiments, it will be apparent to those of ordinary skill in the art that many modifications and variations are possible. Accordingly, the following claims are not to be limited to the disclosed embodiments but rather are intended to additionally cover modifications and variations thereof.

1. A threaded pill caddy, comprising:
a lower portion having a lower end and an upper end;
means carried by the exterior of said lower portion for engaging a bottle cap;
an upper portion having a lower end and an upper end, said lower end of said upper portion being positioned on top of said upper end of said lower portion;
a wall positioned between said lower end of said upper portion and said upper end of said lower portion, said wall and said upper portion defining a space therein, said wall preventing communication between said space and said lower portion; and
a lid constructed of a substantially see-through material, said lid configured to engage said upper end of said upper portion such that said lid can be moved between an open position enabling access to said space and a closed position preventing access to said space.

2. (canceled)

3. The pill caddy of claim 1 wherein said lower portion, said threads, said wall, and said upper portion are integrally constructed.

4. The pill caddy of claim 1 additionally comprising a partition for dividing said space into multiple compartments.

5. The pill caddy of claim 4 wherein said partition is integrally molded into said wall and said upper portion.

6. The pill caddy of claim 4 wherein said partition is a separate piece.

7. The pill caddy of claim 1 additionally comprising a hinge connecting said lid to said upper portion.

8. The pill caddy of claim 1 wherein said upper and said lower portions are cylindrically shaped.

9.-15. (canceled)

16. A bottle top comprising:
a lower cylindrical portion, said lower cylindrical portion having a lower end and an upper end;
means carried by said lower cylindrical portion for engaging the top of a bottle in a childproof manner;
an upper portion having a lower end and an upper end, said lower end of said upper portion being positioned on top of said upper end of said lower portion;
a wall positioned between said lower end of said upper portion and said upper end of said lower portion, said wall and said upper portion defining a space therein, said wall preventing communication between said space and said lower portion;
a lid constructed of a substantially see-through material, said lid configured to engage said upper end of said upper portion such that said lid can be moved between an open position enabling access to said space and a closed position preventing access to said space; and
means carried by said lid and said upper end of said upper portion for enabling said lid to engage said upper portion in a childproof manner.

17. The bottle top of claim 16 wherein said upper portion is cylindrically shaped.

18. The bottle top of claim 16 additionally comprising a hinge connecting said lid to said upper portion.

19. The bottle top of claim 18 additionally comprising a friction fit collar for connecting said hinge to said upper portion.

20. The bottle top of claim 16 wherein said upper portion is constructed of a substantially see-through material.

21. The pill caddy of claim 1 additionally comprising means carried by said lid and means carried by said upper portion for enabling said lid to engage said upper portion in a childproof manner when said lid is in said closed position.

22. A method of preparing pills to be taken, comprising:
simultaneously removing a combination bottle top and pill caddy from a bottle to enable access to said bottle's contents;
removing a dose of said bottle's contents;
opening a lid of said pill caddy;
placing said dose of said contents into said pill caddy;
closing said lid of said pill caddy; and
simultaneously attaching said combination bottle top and pill caddy to said bottle.

23. The method of claim 22 additionally comprising the steps of:
reviewing a label on said bottle for patient, drug, dosage, time of administration and manner of administration information; and
opening said lid of said pill caddy to access said dose.
